(19) United States
(12) Patent Application Publication
(10) Pub. No.: US 2023/0336097 A1
(43) Pub. Date: Oct. 19, 2023

(54) METHOD FOR POWER LIMITING AN APPLIANCE MOTOR

(71) Applicant: Haier US Appliance Solutions, Inc., Wilmington, DE (US)

(72) Inventor: Joseph Wilson Latham, Louisville, KY (US)

(21) Appl. No.: 17/719,873

(22) Filed: Apr. 13, 2022

(51) Int. Cl. H02P 6/06; F25B 49/02

(52) U.S. Cl. CPC H02P 6/06; F25B 49/025; F25B 2700/151; F25B 2600/021; F25B 2600/024; F25B 2700/171; H02P 2207/05

(57) ABSTRACT

A method for operating an appliance motor includes receiving a target speed for the motor, obtaining a power limit for the motor, determining an inverter current limit based at least in part on the target speed and the power limit, determining an inverter output current to achieve the target speed, wherein the inverter output current is limited to the inverter current limit, and supplying the motor with the inverter output current.

### FIELD OF THE INVENTION

The present subject matter relates generally to motors regulated using field-oriented control (FOC) algorithms, and more particularly, to a power limiting method for an FOC-based motor.

### BACKGROUND OF THE INVENTION

Certain conventional air conditioning and refrigeration systems use sealed systems to move heat from one location to another. Certain sealed systems may perform either a refrigeration cycle (e.g., to perform a cooling operation in an appliance such as a refrigerator) or a heat pump cycle (e.g., to heat an indoor room) depending on the appliance and the desired direction of heat transfer. However, the operating principles of both cycles or modes of operation are identical.

Specifically, sealed systems include a plurality of heat exchangers coupled by a fluid conduit charged with refrigerant. A compressor continuously compresses and circulates the refrigerant through the heat exchangers and an expansion device to perform a vapor-compression cycle to facilitate thermal energy transfer. In most sealed systems, an electric motor directly drives the compressor to compress a refrigerant. Notably, such sealed systems often have a certain burst pressure limit per appliance safety standards or regulatory standards.

However, conventional motor controls do not include effective safeguards to avoid the application of excessive power to the motor, which may result in undesirably high sealed system pressures. Notably, conventional power limiting methods rely on limiting the inverter output power. However, one issue with the existing power limiting method is that it is remedial rather than preventative. In this regard, the power limiting method typically waits for power to cross a threshold and then tries to rein it back in by manipulating the motor speed.

Accordingly, an improved method for safely operating an appliance motor would be desirable. More particularly, a method of effectively limiting motor power in an appliance to ensure safe sealed system operation below burst pressure limits would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a method for operating a motor is provided, the method including receiving a target speed for the motor, obtaining a power limit for the motor, determining an inverter current limit based at least in part on the target speed and the power limit, determining an inverter output current to achieve the target speed, wherein the inverter output current is limited to the inverter current limit, and supplying the motor with the inverter output current.

In another exemplary embodiment, a motor assembly is provided including a motor, an inverter electrically coupled to an alternating current power supply and the motor, and a controller in operative communication with the inverter. The controller is configured to receive a target speed for the motor, obtain a power limit for the motor, determine an inverter current limit based at least in part on the target speed and the power limit, determine an inverter output current to achieve the target speed, wherein the inverter output current is limited to the inverter current limit, and supply the motor with the inverter output current.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of a refrigerator appliance according to an example embodiment of the present subject matter.

FIG. 2 is a schematic view of certain components of the example refrigerator appliance of FIG. 1.

FIG. 3 provides an exemplary control schematic and method for regulating operation of an appliance motor according to an exemplary embodiment.

FIG. 4 provides a method of implementing a field-oriented control process for a motor including a power limiting feature according to an exemplary embodiment of the present subject matter.

FIG. 5 provides a plot of a current limit imposed on the exemplary appliance motor of FIG. 3 as a function of target rotational speed according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

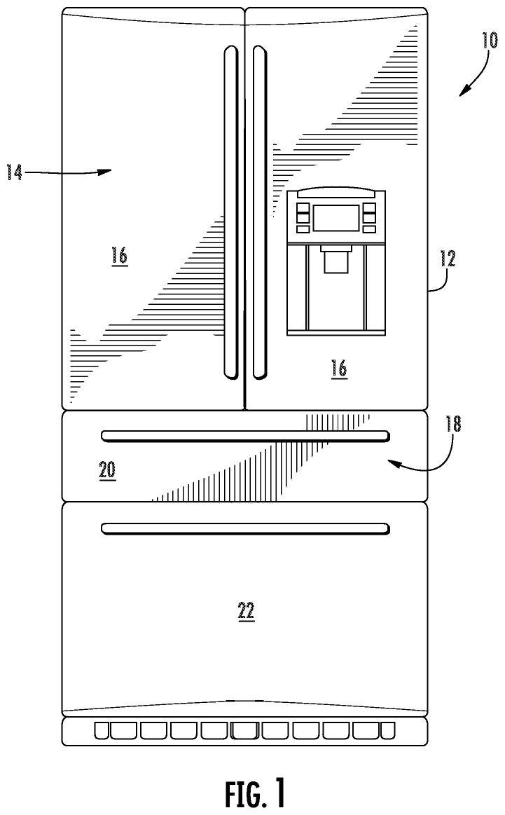

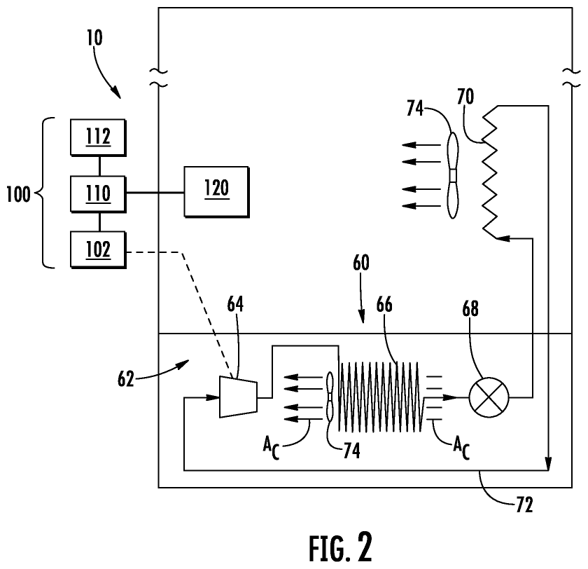

FIG. 1 depicts a refrigerator appliance 10 that incorporates a sealed refrigeration system 60 (FIG. 2). It should be appreciated that the term “refrigerator appliance” is used in a generic sense herein to encompass any manner of refrigeration appliance, such as a freezer, refrigerator/freezer combination, and any style or model of conventional refrigerator. In addition, it should be understood that the present subject matter is not limited to use in refrigerator appliances. Thus, the present subject matter may be used for any other suitable purpose, such as vapor compression within air conditioning units or air compression within air compressors.

In the illustrated example embodiment shown in FIG. 1, the refrigerator appliance 10 is depicted as an upright refrigerator having a cabinet or casing 12 that defines a number of internal chilled storage compartments. In particular, refrigerator appliance 10 includes upper fresh-food compartments 14 having doors 16 and lower freezer compartment 18 having upper drawer 20 and lower drawer 22. The drawers 20 and 22 are “pull-out” drawers in that they can be manually moved into and out of the freezer compartment 18 on suitable slide mechanisms.

FIG. 2 is a schematic view of certain components of refrigerator appliance 10, including a sealed refrigeration system 60 of refrigerator appliance 10. A machinery compartment 62 contains components for executing a known vapor compression cycle for cooling air. The components include a compressor 64, a condenser 66, an expansion device 68, and an evaporator 70 connected in series by fluid conduit 72 that is charged with a refrigerant. As will be understood by those skilled in the art, refrigeration system 60 may include additional components, e.g., at least one additional evaporator, compressor, expansion device, and/or condenser. As an example, refrigeration system 60 may include two evaporators.

Within refrigeration system 60, refrigerant flows into compressor 64, which operates to increase the pressure of the refrigerant. This compression of the refrigerant raises its temperature, which is lowered by passing the refrigerant through condenser 66. Within condenser 66, heat exchange with ambient air takes place so as to cool the refrigerant. A fan 74 is used to pull air across condenser 66, as illustrated by arrows Ac, so as to provide forced convection for a more rapid and efficient heat exchange between the refrigerant within condenser 66 and the ambient air. Thus, as will be understood by those skilled in the art, increasing air flow across condenser 66 can, e.g., increase the efficiency of condenser 66 by improving cooling of the refrigerant contained therein.

An expansion device 68 (e.g., a valve, capillary tube, or other restriction device) receives refrigerant from condenser 66. From expansion device 68, the refrigerant enters evaporator 70. Upon exiting expansion device 68 and entering evaporator 70, the refrigerant drops in pressure. Due to the pressure drop and/or phase change of the refrigerant, evaporator 70 is cool relative to compartments 14 and 18 of refrigerator appliance 10. As such, cooled air is produced and refrigerates compartments 14 and 18 of refrigerator appliance 10. Thus, evaporator 70 is a type of heat exchanger which transfers heat from air passing over evaporator 70 to refrigerant flowing through evaporator 70.

Collectively, the vapor compression cycle components in a refrigeration circuit, associated fans, and associated compartments are sometimes referred to as a sealed refrigeration system operable to force cold air through compartments 14, 18 (FIG. 1). The refrigeration system 60 depicted in FIG. 2 is provided by way of example only. Thus, it is within the scope of the present subject matter for other configurations of the refrigeration system to be used as well.

As described above, sealed refrigeration system 60 performs a vapor compression cycle to refrigerate compartments 14, 18 of refrigerator appliance 10. However, as is understood in the art, refrigeration system 60 is a sealed system that may be alternately operated as a refrigeration assembly (and thus perform a refrigeration cycle as described above) or a heat pump (and thus perform a heat pump cycle). Thus, for example, aspects of the present subject matter may similarly be used in a sealed system for an air conditioner unit, e.g., to perform by a refrigeration or cooling cycle and a heat pump or heating cycle. In this regard, when a sealed system is operating in a cooling mode and thus performs a refrigeration cycle, an indoor heat exchanger acts as an evaporator and an outdoor heat exchanger acts as a condenser. Alternatively, when the sealed system is operating in a heating mode and thus performs a heat pump cycle, the indoor heat exchanger acts as a condenser and the outdoor heat exchanger acts as an evaporator.

Referring still to FIG. 2, an exemplary drive assembly 100 for operating a compressor (e.g., such as compressor 64) will be described according to exemplary embodiments of the present subject matter. As illustrated, compressor 64 may be the device or machine that is used to physically compress refrigerant to facilitate operation of a sealed system (e.g., in refrigeration system 60). However, it should be appreciated that drive assembly 100 may be used in any other suitable application while remaining within the scope of the present subject matter. Moreover, any suitable type of compressor may be used, such as a reciprocating compressor, a plunger compressor, a centrifugal compressor, a screw compressor, a diaphragm compressor, an axial compressor, a rolling piston compressor, a rotary vane compressor, a scroll compressor, or any other suitable type or configuration of compressor.

Drive assembly 100 may include a motor 102 for operating compressor 64. In this regard, motor 102 is generally configured for converting electrical energy into mechanical energy that is used to rotate, translate, or otherwise drive or operate the operating element of compressor 64. Any suitable type or configuration of motor 102 may be used. For example, as used herein, “motor” may refer to any suitable drive motor and/or transmission assembly for operating compressor 64. For example, motor 102 may include a brushless DC electric motor, a stepper motor, or any other suitable type or configuration of motor. For example, motor 102 may include an AC motor, an induction motor, a permanent magnet synchronous motor, or any other suitable type of AC motor. In addition, motor 102 may include any suitable transmission assemblies, clutch mechanisms, or other components. According to exemplary embodiments described below, motor 102 is a synchronous motor, e.g., such as a permanent magnet synchronous motor (PMSM), a brushless DC motor (BLDC), etc. operating under field-oriented control (FOC), as will be explained in more detail below.

Drive assembly 100 may further include an inverter 110 that is operatively coupled to the motor 102 for supplying electrical energy that drives motor 102. For example, inverter 110 may be electrically coupled to a power source 112 (e.g., such as an alternating current (AC) voltage source or mains electricity). Inverter 110 is generally configured for receiving unregulated power from power source 112 and regulating it as needed to drive motor 102. For example, motor inverter 110 may control the frequency of power supplied to motor 102 to control the rotation speed of motor 102. Without inverter 110, unregulated power from power source 112 may operate motor 102 at full speed as soon as the power source 112 was turned on. As explained in more detail below, inverter 110 may implement vector control, commonly referred to as field-oriented control (FOC) to regulate the operation of motor 102.

According to an exemplary embodiment, drive assembly 100 may be operably coupled to a controller 120, which is programmed to operate inverter 110, motor 102, and compressor 64 in the desired manner, as described herein. For example, controller 120 may be operably coupled to inverter 110 for regulating the output power from power source 112 as needed to drive motor 102.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance motor. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to controller 120 through any suitable network(s), such as through a high bandwidth local area network (LAN) or wide area network (WAN). In this regard, for example, controller 120 may further include a communication module or interface that may be used to communicate with one or more other component(s) of an appliance, controller 120, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

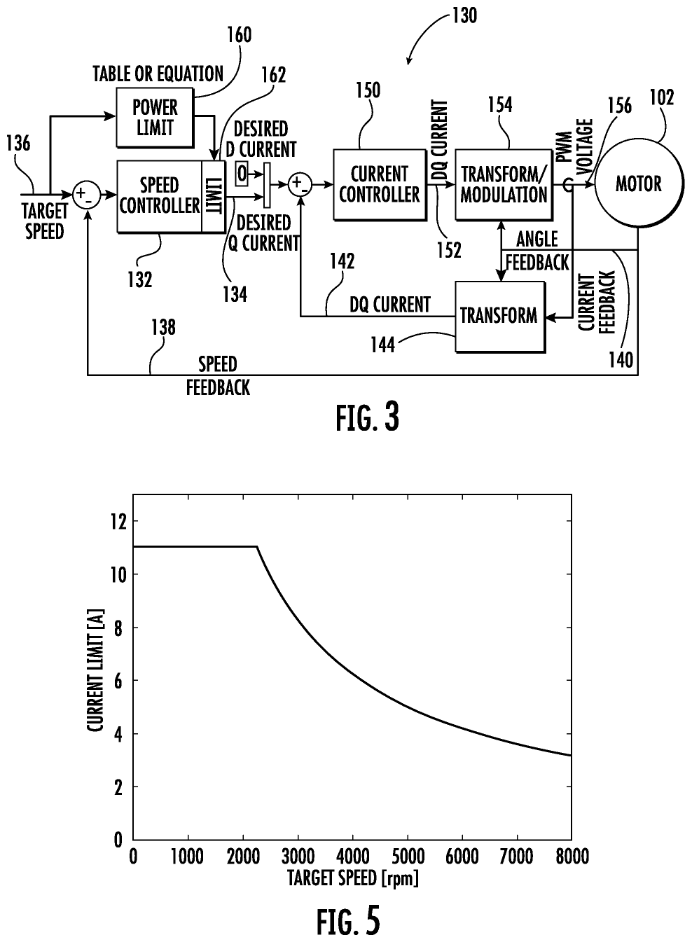

As noted above, controller may implement field-oriented control (FOC) to drive motor 102. Referring now to FIG. 3, an exemplary FOC-based inverter control schematic 130 will be described according to exemplary embodiments of the present subject matter. Although a brief summary of FOC is provided below, additional details are omitted for brevity but would be understood by one having ordinary skill in the art. It should be appreciated that variations and modifications may be made to the exemplary control systems described herein while remaining within the scope of the present subject matter.

In general, field-oriented control, also known as vector control, is a technique used to control synchronous motors such as permanent magnet synchronous motors (PMSM), brushless DC motors (BLDC), etc. Implementation of FOC may generally rely on a transformation of stator currents from a stationary reference frame (also referred to as the three-phase or A-B-C reference frame) to a rotor flux reference frame (also known as direct-quadrature or d-q reference frame). For example, a current space vector may be generated from the combination of direct (d) and quadrature (q) components, which are defined based on the alignment with the rotor field.

In general, the q-axis current generates torque, while the d-axis current does not (except in the case of salient motors). Accordingly, a typical FOC will set a desired d-axis current to zero, while setting the desired q-axis current via a speed controller (e.g., a proportional-integral controller) based on the error between the target speed and feedback speed (e.g., actual motor speed). As illustrated in FIG. 3, a speed controller 132, which may be a proportional-integral controller, is generally configured to output a desired motor current in the d-q phase (e.g., as identified generally by reference numeral 134). As noted above and illustrated in FIG. 3, the desired d-axis current is typically zero, while the q-axis current is the current needed to minimize the error between a target speed (e.g., identified generally by reference numeral 136) and the actual motor speed (e.g., as identified generally by reference numeral 138).

It should be appreciated that any suitable method or device may be used to obtain the actual motor speed. For example, according to an exemplary embodiment, the motor speed may be determined by measuring a motor frequency, a back electromotive force (EMF) on the motor, or a motor shaft speed (e.g., using a tachometer), etc. It should be appreciated that other systems and methods for monitoring motor speed may be used while remaining within the scope of the present subject matter. In addition, it should be appreciated that other motor variables may be used and acquired to implement the FOC algorithm, such as the stator current and rotor position (e.g., as identified generally by reference numeral 140). It should be appreciated that these parameters may be obtained using sensors or using sensorless techniques.

According to the illustrated embodiment, actual motor currents 142 are subtracted from the desired motor currents 134 before the difference is passed into a current controller, as described below. Specifically, according to the illustrated embodiment, the current applied to the motor 102 may be measured and fed back through a current transformation block 144. This current transformation block may be configured for converting the three-phase applied current to the d-q phase currents, as understood by one having ordinary skill in the art. It should be appreciated that current transformation block 144 may additionally include one or more filters, may implement one or more signal conditioning techniques, etc.

Referring still to FIG. 3, the difference between the desired motor currents 134 and the actual motor currents 142 may then be fed to a current controller 150 that is generally configured to receive the d-axis and q-axis currents 134 from speed controller 132 and generate a voltage space vector (e.g., identified generally by reference numeral 152) that should be applied to motor 102 to achieve the desired motor currents 134. According to the illustrated embodiment, the voltage space vector 152 may pass into a voltage transformation block 154 that outputs the desired three-phase pulse width modulated voltage (e.g., identified generally by reference numeral 156) to the motor 102. Notably, this voltage transformation block 154 may rely at least in part on the rotor position 140 in order to properly generate the stator magnetic fields.

As used herein, the terms “direct-quadrature,” “dq-phase,” and the like are generally intended to refer to voltages and/or currents that have been converted or transformed from a three-phase (e.g., A-B-C reference frame) electrical voltage or current to the direct-quadrature reference frame. In this regard, for example, the motor currents may be represented in the d-q reference frame as two orthogonal components that can be visualized with a vector. The d-axis component may correspond to the magnetic flux generated by the stator, while the q-axis component may correspond to the torque as determined by the speed of the motor determined by the rotor position.

As explained briefly above, methods for limiting the power output of FOC-controlled motors include using the power monitor in the inverter micro software to monitor and limit the inverter output power. For example, the output power may be calculated in the inverter software is based on the following equation, where V_{d}, V_{q} are the d-q phase voltages calculated by the current PI controllers, and I_{d}, I_{q} are the measured d-q phase current feedback (after transformation from abc):

$$P = \frac{3}{2} ( {V}_{d} {I}_{d} + {V}_{q} {I}_{q} )$$

Notably, however, the power may be sampled and/or calculated every 50 milliseconds and then averaged over a number of samples, e.g., over a 50 sample effective window. Accordingly, the power feedback is received after a delay of approximately 2.5 seconds. The power may then be reported to the main board, e.g., a controller. When the reported power exceeds some threshold, a mitigation algorithm may kick in that drops the target speed to limit the power. Notably, however, power limiting control that is based on inverter output power is remedial rather than preventative, e.g., having to wait for power to cross a threshold and then try to rein it back in by manipulating the speed.

Accordingly, aspects of the present subject matter may be generally directed to improved power limiting methods for an FOC-based motor. Specifically, as illustrated for example in FIG. 3, the inverter control may further include a power limiting block 160 that receives a target motor speed 136 and determines a desired power limit that is to be applied to speed controller 132, e.g., as indicated generally by limit 162 in FIG. 3. The method for imposing such a power limit 162 will be described in further detail below.

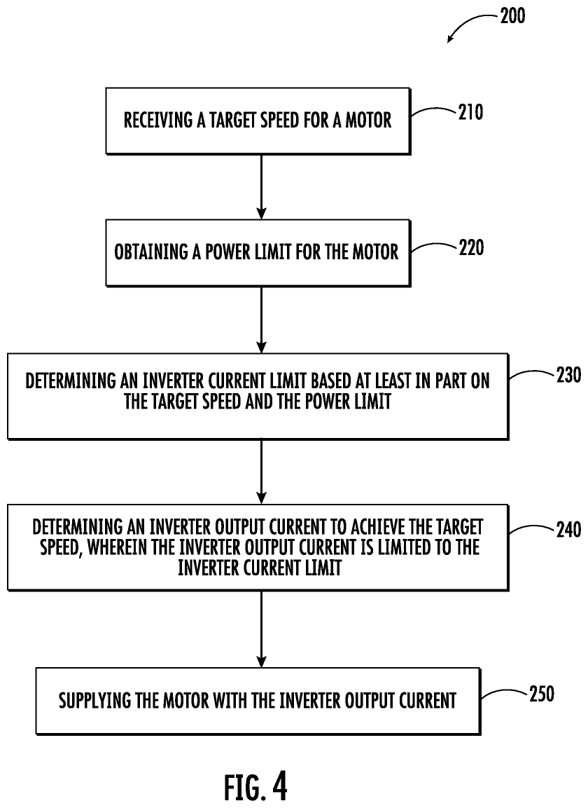

Referring now to FIG. 4, an exemplary method 200 of operating a motor will be described according to an exemplary embodiment of the present subject matter. Method 200 may be used to operate any suitable motor, such as motor 102, or may be adapted for controlling any other suitable motor type and configuration. According to an exemplary embodiment, controller 120, inverter control 130, or some combination therebetween may be programmed or configured to implement method 200. Thus, method 200 is discussed in greater detail below with reference to motor 102.

Referring now specifically to FIG. 4, method 200 may include, at step 210, receiving a target speed for a motor. For example, continuing the example from above, drive assembly 100 may include motor 102 which is mechanically coupled to compressor 64 of sealed refrigeration system 60 of refrigerator appliance 10. The target speed (denoted herein as ωₘ*) may be the motor speed needed to drive compressor 64 to achieve the target sealed system demand and cooling needs for the refrigerator appliance 10. Although method 200 is described herein as being used to regulate motor 102 and compressor 64, it should be appreciated that aspects of the present subject matter may include the operation of motors for another purpose and/or in another appliance. Moreover, the target speed may be obtained from any suitable controller or other source in any other suitable manner.

Step 220 includes obtaining a power limit for the motor. In this regard, the power limit may be a power limit beyond which the motor should not be operated during existing conditions. The power limit (denoted herein as Pₗᵢₘ) may be determined in any suitable manner, may be fixed or variable, and may be supplied from any suitable source. For example, according to an exemplary embodiment, the power limit is a fixed wattage (e.g., 1000 Watts, 1200, Watts, 1500 Watts, etc.) that is programmed into the appliance controller, motor controller, etc.

According to still other exemplary embodiments, the power limit may vary as a function of the target speed. In this regard, for example, obtaining the power limit for the motor comprises determining the power limit as a function of the target speed. The relationship between the power limit and the target speed may be determined in any suitable manner. For example, the controller 120 may be programmed with a lookup table that associates the power limit with specific target motor speeds. In addition, or alternatively, the relationship may be contained in one or more regression equations, mathematical models, or may be determined in any other suitable manner.

Step 230 includes determining an inverter current limit based at least in part on the target speed and the power limit. In this regard, the inverter current limit may be a limit (e.g., as illustrated schematically by reference numeral 162 in FIG. 3) on the q-axis desired motor current 134 output from the speed controller 132. For example, motor power may be modeled using the equation below, where ωₘ is the motor speed, k_{T} is a motor torque constant, and I_{q} is the motor current (e.g., the q-axis current in the d-q phase).

P=Torque·ωₘk_{T}I_{q}ωₘ

Using this equation, for a given target speed for the motor (ωₘ*) and a power limit for the motor (Pₗᵢₘ), and with a known motor torque constant (k_{T}), the inverter current limit for the motor (Iₗᵢₘ) may be calculated. It should be appreciated that the motor torque constant (k_{T}) may be determined empirically or in any other suitable manner. In general, the motor torque constant (k_{T}) may be a function of the number of motor poles, a rotor flux constant (λ), and any other suitable factors. For example, the following equation may be used to model the inverter current limit for the motor (Iₗᵢₘ):

$${I}_{lim} = \frac{{P}_{lim}}{{k}_{T} {ω}_{m}^{*}}$$

Referring now briefly to FIG. 5, an exemplary plot of the inverter current limit as a function of the target motor speed is illustrated. As shown, the inverter current limit generally changes inversely with target speed (e.g., decreases as speed increases). In addition, at lower motor speeds, the inverter current limit may be modified to prevent the generation of prohibitively large currents. For example, as illustrated, between target speeds of 0 and 2200 revolutions per minute, a max current limit may be implemented or otherwise may be incorporated into the inverter current limit. For example, the max current limit may be preprogrammed as a motor parameter, e.g., at a current such as 8 amps, 11 amps, 15 amps, etc. In the event the calculated inverter current limit would otherwise exceed this max current limit, the inverter current limit may be limited to the max current limit.

Although the inverter current limit is illustrated herein as being obtained from a plot such as that provided in FIG. 5, it should be appreciated that other means for obtaining or determining the inverter current limit are possible and within the scope of the present subject matter. For example, the inverter current limit may be calculated using an equation such as that provided above, may be stored in a lookup table, or may be determined in any other suitable manner.

Step 240 includes determining an inverter output current to achieve the target speed, wherein the inverter output current is limited to the inverter current limit. In this regard, speed controller 132 may include a feedback control algorithm (e.g., such as a proportional-integral control) that determines a desired motor current that results in the actual motor speed being driven to the target speed. If the desired motor current exceeds the inverter output current, the inverter current is limited accordingly.

Step 250 may include supplying the motor with the inverter output current. In this regard, continuing the example from above, current controller 150 may receive the inverter output current (limited by the inverter current limit) and may generate the voltages necessary to provide that current to motor 102. According to exemplary embodiments, enforcing the inverter current limit Iₗᵢₘ may be achieved by setting the saturation limits in speed controller 132. In this regard, for a given target speed, once the limit is reached, the speed controller 132 (e.g., proportional-integral controller) may no longer be able to accelerate the motor and it will naturally steady out at some lower speed.

FIG. 4 depicts an exemplary control method and models having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using inverter control schematic 130 and motor 102 as an example, it should be appreciated that these methods may be applied to the operation of any suitable motor type and configuration.

As explained above, aspects of the present subject matter are directed to a method for implementing field-oriented control (FOC) to facilitate power limiting or control in an inverter motor, e.g., that may be used to drive a compressor in an air conditioner or any other suitable sealed system. Generally, a power monitor in the inverter micro software may be used to monitor and limit the inverter output power, and the monitored power may be then reported to a mainboard or other controller. Further, to avoid burst pressures of a sealed system or design limits of the inverter, power supplied via the inverter control may be limited. In addition, the existing power limiting method may wait for power to cross a threshold and then try to rein it back in by manipulating the speed which is remedial rather than preventative.

In order to overcome the aforementioned problems, aspects of the present subject matter may include FOC-based motor power limiting in the inverter air conditioner. The FOC based motor power limiting may include an inverter control limit that provides the ability to set a real power limit as well as potentially a means to set limits based on actual speeds, applied torques, and maximum desired operating pressures. The proposed method may apply specifically to synchronous motor (PMSM, BLDC, etc.) operating under FOC and extends beyond compressor applications.

For example, the present invention may incorporate a motor output power limit into the FOC by noting that the power is equal to the product of speed and motor torque, where the motor torque is equal to a torque constant multiplied by the q-axis current. By limiting the magnitude of the desired q-axis current, the power may be limited by setting the appropriate limit value in the speed controller and updating it when the target speed changes. This gives a current limit that inversely changes with speed, i.e., decreases as speed increases. Additionally, the power limit can be manipulated by applying different limits at different speeds, or whatever conditions might be pertinent (e.g., pressure). The proposed method may not require any oversight from the mainboard such that it is able to continue operating on its own without faulting out. Further, a user can set a low-speed current limit that avoids overheating during a locked rotor test.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a motor, the method comprising:
receiving a target speed for the motor;
obtaining a power limit for the motor;
determining an inverter current limit based at least in part on the target speed and the power limit;
determining an inverter output current to achieve the target speed, wherein the inverter output current is limited to the inverter current limit; and
supplying the motor with the inverter output current.

2. The method of claim 1, wherein the power limit is a fixed wattage.

3. The method of claim 1, wherein obtaining the power limit for the motor comprises:
determining the power limit as a function of the target speed.

4. The method of claim 1, wherein determining the inverter current limit based at least in part on the target speed and the power limit comprises using the following equation:
$${I}_{lim} = \frac{{P}_{lim}}{{k}_{T} \cdot {ω}_{m}^{*}}$$
where: Iₗᵢₘ=the inverter current limit for the motor;
Pₗᵢₘ=the power limit for the motor;
k_{T}=a motor torque constant; and
ωₘ*=the target speed for the motor.

5. The method of claim 4, wherein the motor torque constant (k_{T}) is a function of a number of rotor poles and a rotor flux of the motor.

6. The method of claim 4, wherein determining the inverter current limit based at least in part on the target speed and the power limit comprises:
limiting the inverter current limit (Iₗᵢₘ) to a max current limit for the motor.

7. The method of claim 6, wherein the max current limit is 11 amps.

8. The method of claim 1, wherein the inverter current limit is stored in a lookup table.

9. The method of claim 1, further comprising:
implementing field-oriented control (FOC) using the inverter output current.

10. The method of claim 1, wherein the motor is a synchronous motor.

11. The method of claim 1, wherein the motor is operably coupled to a compressor of a sealed system, and wherein the target speed is received from a controller of the sealed system.

12. The method of claim 11, wherein the sealed system is part of a refrigerator appliance or an air conditioner unit.

13. A motor assembly comprising:
a motor;
an inverter electrically coupled to an alternating current power supply and the motor; and
a controller in operative communication with the inverter, the controller being configured to:
receive a target speed for the motor;
obtain a power limit for the motor;
determine an inverter current limit based at least in part on the target speed and the power limit;
determine an inverter output current to achieve the target speed, wherein the inverter output current is limited to the inverter current limit; and
supply the motor with the inverter output current.

14. The motor assembly of claim 13, wherein the power limit is constant or is determined as a function of the target speed.

15. The motor assembly of claim 13, wherein determining the inverter current limit based at least in part on the target speed and the power limit comprises using the following equation:
$${I}_{lim} = \frac{{P}_{lim}}{{k}_{T} \cdot {ω}_{m}^{*}}$$
where: Iₗᵢₘ=the inverter current limit for the motor;
Pₗᵢₘ=the power limit for the motor;
k_{T}=a motor torque constant; and
ωₘ*=the target speed for the motor.

16. The motor assembly of claim 15, wherein the motor torque constant (k_{T}) is a function of a number of rotor poles and a rotor flux of the motor.

17. The motor assembly of claim 15, wherein determining the inverter current limit based at least in part on the target speed and the power limit comprises:
limiting the inverter current limit (Iₗᵢₘ) to a max current limit for the motor.

18. The motor assembly of claim 13, wherein the inverter current limit is stored in a lookup table.

19. The motor assembly of claim 13, wherein the controller is configured to:
implement field-oriented control (FOC) using the inverter output current.

20. The motor assembly of claim 13, wherein the motor is operably coupled to a compressor of a sealed system, and wherein the target speed is received from a controller of the sealed system.
